(19) United States
(12) Patent Application Publication
(10) Pub. No.: US 2001/0031307 A1
(43) Pub. Date: Oct. 18, 2001

(54) Spent hens for use in pet food

(76) Inventor: Deena Krestel-Rickert, Chesterfield, MO (US)

Correspondence Address: DCV Inc., Attn: Legal Department, 3521 Silverside Road, Quillen Building, Wilmington, DE, 19810, US

(21) Appl. No.: 09/761,087

(22) Filed: Jan. 16, 2001

Related U.S. Application Data
(60) Provisional application No. 60/176,447, filed on Jan. 14, 2000.

(51) Int. Cl. A23L 1/315

(52) U.S. Cl. 426/644

(57) ABSTRACT

The invention is a palatable, high protein, low ash pet food product. This pet food product is made up of the soft tissue (striated muscle, viscera, and other organ tissue) of spent hens. It is preferred that a preservative and/or an antioxidant be added to the soft tissue to keep the product clean and efficacious.

### RELATED APPLICATIONS

This application claims the benefit of U.S. Provisional Application No. 60/176,447, filed on Jan. 14, 2000.

### FIELD OF THE INVENTION

The present invention relates to the use of spent hens in pet food. More specifically, the invention relates to the use of the soft tissue of spent hens (i.e. striated muscle, viscera, and other organ tissue) to provide a high protein, low ash food product for pets.

### BACKGROUND OF THE INVENTION

Several years ago the meat (striated muscle only) from spent hens was being utilized in the human food market in soups and chicken tenders. However, with the genetically enhanced broiler, it made economic sense to use the tender broiler meat for those products because the meat yields are so much higher than those from spent hens. With the human consumption of light spent hens declining, the U.S. egg industry still needs to have some outlet for aging hens. Today, there still exists a small market where comminuted spent hen meat is used in chicken hot dogs or school lunch programs. The remaining birds, which are the majority, are either rendered, taken to landfill or are composted.

The use of landfills and composting are not viable options for the long term because of environmental problems. Using landfills for disposing of spent hens is illegal in some states and continues to grow as a problem in other states. In addition, ground water and soil contamination could be a problem when hens are disposed of in this manner having a direct affect on the water and food we consume as humans. Another outlet is that of rendering plants. That outlet, however, provides a low or negative return to the egg industry at this moment. This environmental issue will only continue to grow over time and worsen unless some other viable means of disposing these animals comes to fruition. Our product and process is an answer to this problem in addition to providing a quality protein to pets.

Since chicken products are widely used in pet foods today, it is applicants discovery that the inclusion of the protein from spent hens could be valuable for the feeding of pets. It has been demonstrated that pets like this protein product and it fits nutritionally well into a high quality pet food. In addition, when the process includes the separation of bones and feathers from the spent hen protein it would yield a low ash product. There is always a need for low ash products in pet foods.

### SUMMARY OF THE INVENTION

In one aspect, the invention is directed to a low ash pet-food product comprising soft tissue obtained from non-eviscerated spent hens.

In a second aspect, the invention is directed to a method for making a low ash pet-food product, the method comprising removing skin, feathers, head, beak, feet, legs and bones from a non-eviscerated spent hen.

### DETAILED DESCRIPTION OF THE INVENTION

The present invention provides a pet food product which is high in protein, very palatable and low in ash. In particular, the product is preferably obtained from spen hens which have been put through a process to remove all non-soft tissue. Non-soft tissue is defined as feathers, bones, skin, feet, legs, and head. The remaining product is the soft tissue. Soft tissue is defined as all tissue other than non-soft tissue. As such, soft tissue will generally comprise the striated muscle, viscera, and other organ tissue. It is this soft tissue which makes up the product of this invention. It is critical that the spent hen not be eviscerated as the viscera is an important part of this product.

The use of spent hen protein, obtained from use of the soft tissue, by the pet food industry provides a need for all interested parties for the following reasons: it provides a palatable material which is both a proven winner with pets and also provides good protein nutrition; it provides a reasonably priced low ash high quality protein; it provides an environmentally friendly method of light spent hen disposal; and it provides a solution to the spent hen disposal problem in the table egg industry.

Below is a detailed description of the product of this invention and a preferred process for making this pet food product.

The Raw Material

The product is produced from spent hens. Spent hens are defined as laying hens that have reached an age of approximately 18 months and are no longer at peak egg production. Unless they are forced into a moult for further egg production, the birds are eventually slaughtered.

The Process

These birds are slaughtered, preferably gassed with carbon dioxide, and then conveyed into a process, usually using a deboner, where the bones, heads, feet, legs, skin and feathers (non-soft tissues) are separated by a series of sieves from the soft tissues (striated muscle, viscera, and other organ tissue). A commercial deboner is a preferred product for removing non-soft tissue from the spent hens. The birds are not eviscerated prior to the “deboning” process as the viscera is an important part of the inventive product. For use of this product in petfood, it is preferred that the feed is removed from the birds two days prior to being slaughtered so as to minimize contents in the crop and intestines and hence significantly reduce microbiological counts. The ethical nature of this feed withdrawal has been investigated, and the USDA does not have a regulation prohibiting such practice.

The product is then preferably passed through a series of chillers (of contherms) so as to chill the product and minimize microbial growth. The body temperature of the birds going into the separator is preferably about 106° F. After the separator, from friction alone (no heat is intentionally added) the product temperature should be in the range of 110° to 130° F. and more preferably, 120°F. After the chillers, the product temperature is preferably brought down to a range of 30°-45° F., and more preferably 35° F.

The product can then be incorporated into pet food in several different forms, such as frozen, dried, fresh, homogenized, hydrolyzed, etc.

The Final Product

Palatability

The palatability of this product was evaluated in soft-moist pet food and baked treats. The comparative products were produced with either dried chicken concentrate or chicken. The palatability of the spent hen meat product showed significant preference over the current products being used.

Preservatives Added During the Process

As the raw meat is processed from the live bird to the final stabilized and chilled soft tissue product, it is preferred that one or more preservatives be added. The preservatives are obviously used to stabilize the product for shipmemt as well as to extend the shelf life of the product before use by the petfood customer. It is clearly preferred that the preservatives funtion as anti-microbials. Some examples of preservatives that can be used in the invention include basically any organic or inorganic acid. In particular, the following can be used: malic acid, citric acid, sulfuric acid, phosphoric acid, calcium propionate, sodium propionate, mono and di-glycerides, nitrites, nitrates, disodium EDTA and combinations thereof. Those having skill in the art are familiar with preservatives that are effective for the purposes set forth in this invention.

In a preferred embodiment, as a stabilizer and preservative phosphoric acid can be added. It is preferred that about 1%-15% of phosphoric acid be added to the 9338 lb of meat processed which had chemicals added.

It is also preferred that an antioxidant be used to keep the product from going rancid and to keep it stable. For an antioxidant, Amerol, provided by Harcross, is an example of an antioxidant that was used by applicants. The Amerol can be diluted by 50% in order to preserve all of the meat that is being processed. Approximately 0.005% of the Amerol is preferably used in 9338 lb of processed meat. Although Amerol was the antioxident used in the example, the inventor contemplates that any other antioxidant can be used in place of or in combination with Amerol to achieve the benefits of the invention. Some examples of antioxidants include any natural or synthetic antioxidant such as Vitamin C, Vitamin E, sulfites, herbs, extracts, mixed tocopherols, NaturOx™, Butylated Hydroxyanisole (BHA), Butylated Hydroxytoluene (BHT), Ethoxyquin, Pet Ox™, and related products.

Safety

The safety of the product has been discussed in the examples where it was shown to be clean microbiologically as well as bacteriologically. In addition, the lead count was virtually below levels of detectability in the product. These are all positive signs of this product being a safe product to feed to pets.

The advantageous properties of this invention can be observed by reference to the following examples that illustrate the invention.

### EXAMPLES

### Example 1

In the process presently used by the applicant, live birds at approximately 18 months of age (can have feed removed for two days prior to killing) are gassed with CO₂. These birds are then conveyed to a Beehive® deboner. (Temperature of live bird is approximately 105-106° F.) During deboning the skin, feathers, heads, beaks, feet, legs and bones are removed. As the meat is being deboned, phosphoric acid (approximately 10%), as a preservative, and Amerol, as an antioxidant, are being metered in. (The temperature of the processed meat out of the deboner is approximately 120° F.) The soft tissues (striated muscle, viscera, and other organ tissue) are then moved through contherms (chillers) to reduce the meat temperature to approximately 36-40° F. The fresh finished product is then loaded in totes and transported to the pet food customer in a refrigerated truck. Excess product may be stored in a chilled room or frozen in 40-50 lb. nude blocks.

### Example 2

The following is a summary of the trial run at Walbaum Farms in Nebraska on July of 1999 where the spent hen meat/viscera product was produced by DuCoa. This is the same product on which microbiological tests were run as well as the product that was included in a finished petfood on which microbiological analytical data was also collected.

This high protein, high value poultry product has potential use in pet foods. This information has been presented with supporting data for consideration to both AAFCO and FDA. A new ingredient name is being proposed for this product. The proposed name is “Mechanically Separated Poultry, Feed Grade”. The term mean to define the product resulting from the grinding and mechanical separation of the whole carcasses of poultry, inclusive of flesh, viscera and its contents, but exclusive of bone and feathers except in amounts as may occur unavoidably in good processing practices. It shall be suitable for use in heat-processed animal food, and shall contain no more than 0.1% calcium. If it bears the name descriptive of its kind, it must correspond thereto.

The purpose of the following is to clarify the characteristics of the product, the process, analytical data, and the proposed ingredient name for consideration by FDA and AAFCO.

The Raw Material

The product is produced from laying hens that have reached an age of approximately 18 months and are no longer at peak egg production. Unless they are forced into a moult for further egg production, the birds are eventually either rendered, landfilled or composted.

The Process

These birds are gassed with carbon dioxide and conveyed into a deboner (Beehive®) where the bones, heads, feet, skin and feathers are separated by a series of sieves from the soft tissues, in this case the striated muscle, viscera, and other organ tissue. The birds most likely will need to be defeathered prior to the deboner such that the waste stream of feathers and bone (separated) are utilizable to the renderers. This increases the value of the waste stream for feather meal and meat and bone meal. If feathers and bones are combined the value to the renderer is zero if not a negative since further processing would be required before sale.

DuCoa has gotten agreement from several laying operations, should this meat product be used in petfood, to remove feed from the birds six to eight hours prior to being gassed so as to minimize contents in the crop and intestines and hence significantly reduce microbiological counts. We have investigated the ethical nature of this feed withdrawal, and were advised by our consultants, that USDA does not have a regulation prohibiting such practice.

After running through the deboner, the product passes through a series of chillers (contherms) so as to chill the product and minimize microbial growth. The body temperature of the bird going into the separator is 106° F. After the separator, from friction alone (no heat is intentionally added), the product temperature is 120° F. and after the chillers it is brought down to approximately 35° F. The product is loaded into totes and is then shipped to customers in refrigerated trucks.

Analytical Data

The final product has the appearance of canned pet food and is similar in texture. In a trial conducted in July 1999, samples of the product were collected, frozen and then shipped on ice to the analytical laboratory. The following analytical data was gathered. The data shown reflects that only from non-eviscerated birds which is the product that the applicant is proposing.

Microbial and Bacterial Analyses

Following is the analytical on the microbiological activity:

| | SDNP: | TCM3: | | | |
|---|---|---|---|---|---|
| | Salmo- | Total | TPC: Aerobic | TYM: | TYM: |
| | nella/ | Coliforms: | Plate Count: | Mold: | Yeast: |
| | 25 g: | MPN/g | Cfu/g | cfu/g | cfu/g |
| 5° C. | Negative | <3 | 1.8 × 10² | 10 | <10 |
| 35° C. | | | | | |
| 5° - Day 7 | | <3 | 70 | 30 | <10 |
| 35° - Day 7 | | <3 | 20 | 10 | <10 |
| 5° - Day 14 | | | 20 | 10 | <10 |
| 35° - Day 14 | | | 70 | 40 | <10 |
| 5° - Day 30 | | | 60 | | |
| 35° - Day 30 | | | <10 | | |

(Tests were omitted as time progressed since negative data indicated clean product.

These test results revealed that this product is clean of microbiological and bacterial activity.

Proximate Analysis

The proximate analysis of the product, on an as is basis, revealed the following:

| | |
|---|---|
| Moisture | 62.6% |
| Protein | 15.5% |
| Fat | 15.9% |
| Ash | 4.6% |

Lead

At the recommendation of Sharon Benz with FDA, a lead test was conducted as an indicator of heavy metal contamination in the product. The results of the lead test are as follows:

| | | |
|---|---|---|
| Lead | <0.0500 | ppm |

Essentially, the reading indicated that the lead levels in the product were below detectable levels and therefore indicative that any other heavy metals, if they existed, would also be below detectable levels.

Summary

The data supporting the safety of this product has been summarized in the tables above. All data revealed that the processed product was clean microbiologically as well as bacteriologically. In addition, the lead count was virtually below levels of detectability in the product. These are all positive signs of this product being a safe product to feed to pets.

### Example 3

The purpose of this example is to show that the soft tissue from spent hens can be kept microbially clean using the process of the invention all the way to the finished pet food product.

Collection of Samples

Three different representative batches of product were manufactured with a total of 16 samples being collected. In order to assure that the samples were collected in a manner acceptable to AAFCO and the FDA, an inspector from the Department of Agriculture in Harrisburg, Pa., was present during the entire process and has filed his report.

Three different batches of product were run according to the following process:

1. Samples of fresh frozen ground “Mechanically Separated Poultry, Feed Grade” were collected to be analyzed for microbiological and proximate analyses (Batch 1 Samples 1-1, 1-2, and 1-3) as they came out of the grinder. (The term “Mechanically Separated Poultry, Feed Grade” is a proposed AAFCO term to define the soft tissue of a spent hen).

2. Samples of slurry were collected after enzymes were added.

3. Samples were collected at the pre-conditioner prior to the extruder.

4. Samples were collected at the output of the extruder.

5. Samples were collected out of the dryer.

6. Samples of the dry batch mix alone were collected before being added to the poultry mix.

Sampling Technique

The sampling methodology used was according to the sampling protocol in the AAFCO 1994 Feed Inspectors Manual.

Sterile gloves were used to obtain all samples, non-contaminated containers/collection implements were covered in aluminum foil (new foil used for each sample and batch collected). Samples, where appropriate, were comprised of ten sub-samples, mixed and then divided in two. Samples were blinded.

Laboratory testing was conducted at Microbac, Erie Division located at 1962 Wager Road, Erie, Pa. 16509.

Actual Operational Parameters

Other parameters used are as follows:

Residence time of product in the pre-conditioner: 2.5 minutes at 100° C.

Extrusion rate of the product: 7000 lb/hr

Moisture in the extruder: 25% ±2

Temperature in extruder: 125-138° C.

Pressure in extruder: 34-37 ATM

Time in extruder: 45 seconds

Time of product in dryer: 20 minutes (3 zoned dryer—Zone 1 and 2 between 220-225° F., Zone 3—no flame)

Results

We obtained confirmation that the raw “Mechanically Separated Poultry, Feed Grade” used was clean and that the dry extruded dog food is clean.

1. A low ash pet-food product comprising soft tissue obtained from non-eviscerated spent hens.

2. The pet-food product of claim 1 wherein the soft tissue comprises striated muscle, viscera, and other organ tissue.

3. The pet-food product of claim 1 further comprising at least one preservative.

4. The pet-food product of claim 3 wherein the preservative is selected from the group consisting of any organic or inorganic acid.

5. The pet food product of claim 3 wherein the preservative is selected from the group consisting of malic acid, citric acid, sulfuric acid, phosphoric acid, calcium propionate, sodium propionate, mono and di-glycerides, nitrites, nitrates, disodium EDTA and combinations thereof.

6. The pet-food product of claim 1 further comprising at least one antioxidant.

7. The pet-food product of claim 6 wherein the antioxidant is selected from the group consisting of Amerol, Vitamin C, Vitamin E, sulfites, herbs, extracts, mixed tocopherols, NaturOx™, Butylated Hydroxyanisole (BHA), Butylated Hydroxytoluene (BHT), ethoxyquin, PetOx™, and combinations thereof.

8. A method for making a low ash pet-food product, the method comprising removing skin, feathers, head, beak, feet, legs and bones from a non-eviscerated spent hen.

9. The method of claim 8 further comprising adding at least one preservative to the non-eviscerated spent hen after removal of skin, feathers, head, beak, feet, legs and bones therefrom.

10. The method of claim 9 wherein the preservative is selected from the group consisting of any organic or inorganic acid or any other preservatives.

11. The method of claim 9 wherein the preservative is selected from the group consisting of malic acid, citric acid, sulfuric acid, phosphoric acid, calcium propionate, sodium propionate, mono and di-glycerides, nitrites, nitrates, disodium EDTA and combinations thereof.

12. The method of claim 8 further comprising adding at least one antioxidant to the non-eviscerated spent hen after/during removal of skin, feathers, head, beak, feet, legs and bones therefrom.

13. The method of claim 12 wherein the antioxidant is selected from the group consisting of Amerol, Vitamin C, Vitamin E, sulfites, herbs, extracts, mixed tocopherols, NaturOx™, Butylated Hydroxyanisole (BHA), Butylated Hydroxytoluene (BHT), ethoxyquin, PetOx™, and combinations thereof.
